(19) United States
(12) Patent Application Publication
(10) Pub. No.: US 2013/0252135 A1
(43) Pub. Date: Sep. 26, 2013

(54) PT-RU NANO-ALLOY/GRAPHENE CATALYST, PREPARATION METHOD AND USE THEREOF

(71) Applicants: Mingjie Zhou, Shenzhen (CN); Linglong Zhong, Shenzhen (CN); Yaobing Wang, Shenzhen (CN)

(72) Inventors: Mingjie Zhou, Shenzhen (CN); Linglong Zhong, Shenzhen (CN); Yaobing Wang, Shenzhen (CN)

(21) Appl. No.: 13/990,129

(22) PCT Filed: Dec. 29, 2010
(86) PCT No.: PCT/CN10/80449

§ 371 Date: May 29, 2013

(51) Int. Cl. H01M 4/86; H01M 8/10; H01M 4/88; H01M 2/16

(52) U.S. Cl. CPC H01M 4/8657; H01M 2/16; H01M 8/1018; H01M 4/88
USPC 429/492; 502/185; 429/524

(57) ABSTRACT

A Pt—Ru nano-alloy/graphene catalyst comprises graphene as a support, and a Pt—Ru nano-alloy loaded on the graphene. The use of graphene as support for the catalyst takes advantage of the ion effect and tow-dimensional ductility of graphene, which increase the stability of the catalyst. The catalyst is prepared by a reverse micelles system method which provides a micro-environment (i.e. water-in-oil microemulsion), so that the particle size of the resulting nano-alloy particles can be regulated easily and is more uniformly distributed. The use of the catalyst in electrochemistry is also disclosed.

### FIELD OF THE INVENTION

The present invention relates to a field of electrochemical energy, and more particularly relates to a Pt—Ru nano-alloy/graphene catalyst used in proton exchange membrane fuel cell. The present invention also relates to a preparation method and a use of the Pt—Ru nano-alloy/graphene catalyst.

### BACKGROUND OF THE INVENTION

Proton exchange membrane fuel cell (PEMFC) is a new generation of power generation device using hydrogen as fuel, besides the general advantages of fuel cell (such as high energy conversion efficiency and environment-friendly, etc.), it has the outstanding advantages of high specific power and specific energy, low working temperature, quick start at room temperature, long life and so on, therefore it could be the most promising fuel cell.

Electro-catalyst of PEMFC is one of the key factors to restrict its commercialization, thus, electro-catalyst researches has become the main contents of the researches of PEMFC. “The biggest regret of chemistry in the 20th century was the failure to develop the excellent fuel cell catalysts.” Lippard pointed out in the comments to the development of chemistry in the 20th century, who was a chairman of the chemistry department of the Massachusetts Institute of Technology.

The preparation methods of catalyst have a great influence on the size and the crystalline state of Pt particle in catalysts, the preparation methods for Pt/C catalyst of the mainly reports are inorganic colloid method, impregnation method, sol-gel method and precipitation method etc. These catalysts prepared by the conventional preparation methods have problems of poor dispersibility in particle, the uneven diameter of particle and harsh reaction conditions. Because the preparation process of catalyst determines the composition and structure of catalyst and thereby affects its catalytic performance, it is very important to study the preparation methods and processes of the catalyst.

The theories of graphene, which have been studied for more than 60 years, has been widely used to study the performance of the different structure of the carbonaceous material. In Science, 2009, vol 324: p 1530, Geim pointed out that graphene is a carbon material having less than 10 layers of the layered structure of graphite molecules, and it has a higher specific surface area (the theoretical specific surface area of graphene can reach to 2620 m²/g), which could provide more metal load position. Meanwhile, the graphene exhibits a strong quantum effect and has a good electronic conductivity. It is calculated according to the first principle that, platinum group elements can be stably loaded on the graphene, and the adsorption of carbon monoxide or hydrogen on the metal platinum particles will be reduced because of the presence of graphene, which facilitates the reaction in the fuel cell. Therefore, the graphene can be used as a good carbon carrier.

### SUMMARY OF THE INVENTION

According to the above problems, one object of the present invention is to provide a preparation method of a Pt—Ru nano-alloy/graphene catalyst, which includes the following steps:

1. preparation of graphite oxide: a graphite oxide is prepared by using graphite powder according to a modified Hummers method;

2. preparation of graphite oxide solution: the prepared graphite oxide is added to water and dispersed by ultrasonic dispersion, a graphene oxide solution with uniform dispersion of monolithic layer is formed;

3. preparation of reverse micelle system: a mixed system containing a surfactant (anionic surfactant or cationic surfactant, such as sodium benzenesulfonate, sodium dodecylbenzenesulfonate, aliphatic sulfate and aliphatic quaternary ammonium salt, etc.), a cosurfactant (e.g., n-octanol, n-nonyl alcohol, n-heptanol and n-hexyl alcohol), an oil phase (e.g., cyclohexane) and a chloroplatinic acid (H₂PtCl₆, with a molar concentration of 0.04 mol/L) and a ruthenium chloride (RuCl₃, with a molar concentration of 0.04 mol/L) aqueous solution is prepared at room temperature, a uniform and stable reverse micelle system is formed under the effect of ultrasonic; and a mass ratio of the surfactant, the cosurfactant and the oil phase is 10:7:1;

4. formation of precursors: the prepared graphene oxide solution is slowly added to the reverse micelle system dropwise;

5. reduction of precursors: the excess reducing agent (such as hydrazine hydrate or sodium borohydride, and a molar amount of the reducing agent is 3 to 10 times of a molar amount of the chloroplatinic acid) is added to the reverse micelle system in a water bath at a temperature of 80° C., such that the chloroplatinic acid, the ruthenium chloride, and the graphene oxide were reduced to Pt, Ru and graphene respectively, and a Pt—Ru nano-alloy is obtained while Pt and Ru are coprecipitated, and an emulsion containing Pt—Ru nano-alloy and graphene is perpared; taking H₂PtCl₆, RuCl₃ for examples, KBH₄ is a reducing agent, the reaction equation is shown as follows:

H₂PtCl₆+KBH₄→Pt+H₂↑+2HCl+KCl+BCl₃

4RuCl₃+3KBH₄→4Ru+6H₂↑+₃KCl+3BCl₃

6. demulsification: a demulsifier (e.g., acetone or anhydrous ethanol, and volume of the demulsifier is 20 to 50% of a volume of cyclohexane) is added to the emulsion in the condition of ultrasonic vibration, and the Pt—Ru nano-alloy is loaded on the carrier of graphene, and a mixed system is prepared;

7. filtering, washing and drying: the mixed system is vacuum filtered, and washed by ethanol and deionized water for several times, filtrated to obtain a graphene loaded with Pt—Ru nano-alloy, then dried to obtain a Pt—Ru nano-alloy/graphene catalyst.

The Pt—Ru nano-alloy/graphene catalyst prepared by the method above contains graphene as a carrier, and a Pt—Ru nano-alloy is loaded on the graphene.

The Pt—Ru nano-alloy/graphene catalyst prepared according to the present invention can be used in the field of the proton exchange membrane fuel cell.

The Pt—Ru nano-alloy/graphene catalyst of the present invention uses graphene as a carrier and takes advantage of the ion effect and tow-dimensional ductility of graphene to increase the stability of the catalyst. The reverse micelles system provides a micro-environment (i.e. water-in-oil microemulsion), which is an ideal place for synthesis of metal nanoparticles, such that the particle size of the nano-alloy particles by this preparation method can be regulated easily and more uniformly distributed.

### BRIEF DESCRIPTION OF THE DRAWINGS

FIG. 1 is a flowchart of a preparation method of a Pt—Ru nano/graphene catalyst according to the present invention;

FIG. 2 is an EDS testing spectrum of the Pt—Ru alloy/graphene catalyst of the Example 1.

### DETAILED DESCRIPTION OF THE EMBODIMENTS

A preparation method of a Pt—Ru nano/graphene catalyst used in the proton exchange membrane fuel cell is provided in the present invention, a loadage of platinum is 5 w % to 80 w %, a graphene is used as a carrier in this kind of catalyst, the catalyst takes the advantages of the ion effect and tow-dimensional ductility of graphene to increase the stability of the catalyst.

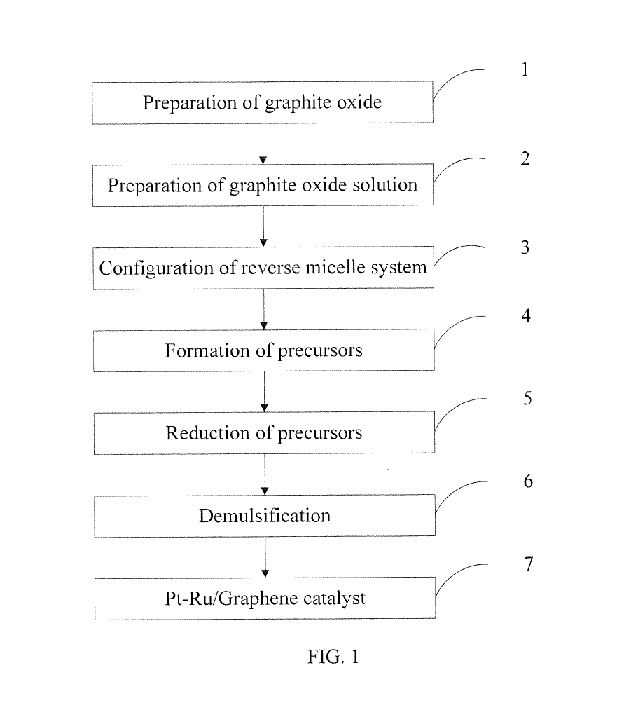

Referring to FIG. 1, the preparation of the Pt/graphene catalyst includes the steps of:

1. preparation of graphite oxide: a graphite oxide is prepared by using graphite powder according to a modified Hummers method;

2. preparation of graphite oxide solution: the prepared graphite oxide is added to water and dispersed by ultrasonic dispersion, a graphene oxide solution with uniform dispersion of monolithic layer is formed;

3. preparation of reverse micelle system: a mixed system containing a surfactant (anionic surfactant or cationic surfactant, such as sodium benzenesulfonate, sodium dodecylbenzenesulfonate, aliphatic sulfate and aliphatic quaternary ammonium salt, etc.), a cosurfactant n-octanol, n-nonyl alcohol, n-heptanal and n-hexyl alcohol), an oil phase (e.g., cyclohexane) and a chloroplatinic acid (H₂PtCl₆, with a molar concentration of 0.04 mol/L) and a ruthenium chloride (RuCl₃, with a molar concentration of 0.04 mol/L) aqueous solution is prepared at room temperature a uniform and stable reverse micelle system is formed under the effect of ultrasonic; and a mass ratio of the surfactant, the cosurfactant and the oil phase is 10:7:1;

4. formation of precursors: the prepared graphene oxide solution is slowly added to the reverse micelle system dropwise;

5. reduction of precursors: the excess reducing agent (such as hydrazine hydrate or sodium borohydride, and a molar amount of the reducing agent is 3 to 10 times of a molar amount of the chloroplatinic acid) is added to the reverse micelle system in the water bath at a temperature of 80° C., so that the chloroplatinic acid, the ruthenium chloride, and the graphene oxide were reduced to Pt, Ru and graphene respectively, and a Pt—Ru nano-alloy is obtained while Pt and Ru are coprecipitated, so an emulsion containing Pt—Ru nano-alloy and graphene is prepared; now taking H₂PtCl₆, RuCl₃ for examples, KBH₄ is a reducing agent, the reaction is as follows:

H₂PtCl₆+KBH₄→Pt+H₂↑+2HCl+KCl+BCl₃

4RuCl₃+3KBH₄→4Ru+6H₂↑₃KCl+3BCl₃

6. demulsification: a demulsifier (e.g., acetone or anhydrous ethanol, and volume of the demulsifier is 20 to 50% of a volume of cyclohexane) is added to the emulsion in the condition of ultrasonic vibration, and the Pt—Ru nano-alloy is loaded on the carrier of graphene, and a mixed system is prepared;

7. filtering , washing and drying: the mixed system is vacuum filtered, and washed by ethanol and deionized water for several times, filtrated to obtain a graphene loaded with Pt—Ru nano-alloy, then dried to obtain a Pt—Ru nano-alloy/graphene catalyst.

In the step of preparing the graphite oxide, including the following steps:

\textcircled{1}. the graphite powder, a potassium persulfate and a phosphorus pentoxide are added to a concentrated sulfuric acid at a temperature of 80° C., and the mixture is stirred uniformly, then cooled for more than 6 hours, washed to neutral, and dried to obtain a sample;

\textcircled{2}. The, dried sample is added to 200 mL to 250 mL of concentrated sulfuric acid at a temperature of 0° C., and then a potassium permanganate is added, the mixture is heat preserved for 5 to 60 minutes at a temperature from 0° C. to 20° C., then maintained for 1 to 2 hours in an oil bath at a temperature 35° C., and slowly added to deionized water containing a hydrogen peroxide, a mixed solution is obtained; and

\textcircled{3}. The mixed solution is hot filtered while the color of the mixed solution becomes bright yellow, then washed with hydrochloric acid, filtered, vacuum dried for 48 hours at a temperature of 60° C. to obtain the graphite oxide.

The Pt—Ru nano-alloy/graphene catalyst prepared by the method above contains graphene as a carrier, and a Pt—Ru nano-alloy is loaded on the graphene.

The Pt—Ru nano-alloy/graphene catalyst prepared according to the present invention can be used in the field of the proton exchange membrane fuel cell.

The Pt—Ru nano-alloy/graphene catalyst of the present invention uses graphene as a carrier and takes advantage of the ion effect and tow-dimensional ductility of graphene to increases the stability of the catalyst. The catalyst is prepared by a reverse micelles system method which provides a micro-environment (i.e., water-in-oil microemulsion), which is an ideal place for synthesis of metal nanoparticles, such that the particle size of the nano-alloy particles by this preparation method can be regulated easily and more uniformly distributed.

The following preferred examples and drawings are provided to further illustrate the technical solutions of the present invention.

### EXAMPLE 1

1. Preparation of graphite oxide: the graphite oxide was prepared according to the modified Hummers method. The specific steps were: 20 g 50 mesh of graphite powder, 10 g of potassium persulfate and 10 g of phosphorus pentoxide were added to concentrated sulfuric acid at a temperature of 80° C., and the mixture was stirred uniformly, cooled for more than 6 hours, washed to neutral and dried to obtain a sample. The dried sample was added to 230 mL of concentrated sulfuric acid at a temperature of 0° C., then 60 g of potassium permanganate was added, the mixture was maintained below 20° C. for 30 minutes, and then maintained in the oil bath at a temperature of 35° C. for 2 hours, 920 mL of deionized water was slowly added. 15 minutes later, 2.8 L of deionized water (containing 50 mL of hydrogen peroxide with a concentration of 30%) was then added, the mixture was hot filtrated while the color of the mixture became bright yellow, and then washed with 5 L of hydrochloric acid with a concentration of 10%, filtrated, and vacuum dried for 48 hours at a temperature of 60° C. to obtain the graphite oxide.

2. Preparation of graphite oxide solution: 0.5 g of obtained graphite oxide was added to 200 mL of water and dispersed by ultrasonic dispersion, a graphene oxide solution with uniform dispersion of monolithic layer was formed.

3. Preparation of reverse micelle system: aliphatic sulfate, n-hexanol and cyclohexane were mixed together with a mass ratio of 100:70:10, and water was added according to a molar ratio of the aliphatic sulfate and the water of 1:7 to obtain a mixed solution, the mixed solution was ultrasonic vibrated for 30 minutes, finally, chloroplatinic acid solution with a concentration of 0.04 mol/L and ruthenium chloride solution with a concentration of 0.04 mol/L of were slowly added to the mixed solution dropwise, and ultrasonic vibrated for 30 minutes to form a transparent reverse micelle system.

4. Formation of precursors: the prepared graphene oxide solution was slowly added to the reverse micelle system dropwise, ultrasonic vibrated for 30 minutes. A mass ratio of the platinum-ruthenium alloy and the graphene was 1:10.

5. Reduction of precursors: excess sodium borohydride was added to the reverse micelle system in a water bath at a temperature of 80° C., and then ultrasonic vibrated for 2 hours, such that the graphene oxide, the chloroplatinic acid and the ruthenium chloride were reduced respectively.

6. Demulsification: 30 mL of demulsifier (acetone) was added to the reverse micelle system in the condition of ultrasonic vibration, then the system was stood until the system was stratified

7. Filtering, washing and drying: the solution was filtered, and then filter cake was washed with ethanol solution and deionized water for several times, and the obtained catalyst was vacuum dried for 2 hours at a temperature of 70° C., then a Pt—Ru nano-alloy/graphene catalyst was obtain.

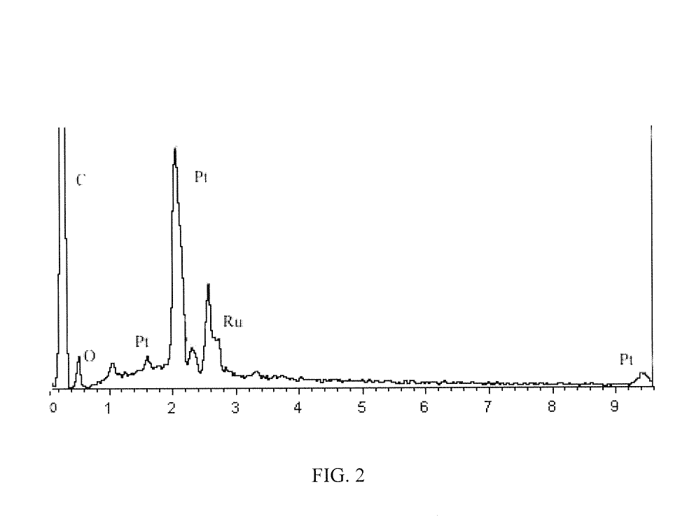

FIG. 2 was an EDS testing spectrum of the Pt—Ru alloy/graphene catalyst of the Example 1. As can be seen from the FIG. 2, the obtained catalyst mainly contained four elements of platinum (Pt), ruthenium (Ru), carbon (C) and oxygen (O). The area corresponding to the peak represented the percentage content of each element. It showed that the percentage content of carbon was much higher than the other elements, a mass ratio in the material was C:O:Pt:Ru=65:4:22:9 according to the calculation results of the peak area.

### EXAMPLE 2

1. Preparation of graphite oxide: the graphite oxide was prepared according to the modified Hummers method. The specific steps were: 20 g 50 mesh of graphite powder, 10 g of potassium persulfate and 10 g of phosphorus pentoxide were added to concentrated sulfuric acid at a temperature of 80° C., and the mixture was stirred uniformly, cooled for more than 6 hours, washed to neutral and dried to obtain a sample. The dried sample was added to 200 mL of concentrated sulfuric acid at a temperature of 0° C., then 60 g of potassium permanganate was added, the temperature of the mixture was maintained below 20° C. for 5 minutes, and then maintained in the oil bath at a temperature of 35° C. for 1 hour, 920 mL of deionized water was slowly added. 15 minutes later, 2.8 L of deionized water (containing 50 mL of hydrogen peroxide with a concentration of 30%) was then added, the mixture was hot filtrated while the color of the mixture became bright yellow, and then washed with 5 L of hydrochloric acid with a concentration of 10%, filtrated, and vacuum dried for 48 hours at a temperature of 60° C. to obtain the graphite oxide.

2. Preparation of graphite oxide solution: 0.5 g of obtained graphite oxide was added to 200 mL of water and dispersed by ultrasonic dispersion, a graphene oxide solution with uniform dispersion of monolithic layer was formed.

3. Preparation of reverse micelle system: sodium benzenesulfonate, n-heptanol and cyclohexane were mixed together with a mass ratio of 100:70:10, and water was added according to a molar ratio of the sodium benzenesulfonate and the water of 1:7 to obtain a mixed solution, the mixed solution was ultrasonic vibrated for 30 minutes, and finally chloroplatinic acid solution with a concentration of 0.04 mol/L and ruthenium chloride solution with a concentration of 0.04 mol/L were slowly added to the mixed solution dropwise, and ultrasonic vibrated for 30 minutes to form a transparent reverse micelle system.

4. Formation of precursors: 10% to 60%, the prepared graphene oxide solution was slowly added to the reverse micelle system dropwise, ultrasonic vibrated for 30 minutes. A mass ratio of the platinum-ruthenium alloy and the graphene was 1:10.

5. Reduction of precursors: excess sodium borohydride was added to the reverse micelle system in a water bath at a temperature of 80° C., and then ultrasonic vibrated for 2 hours, such that the graphene oxide, the chloroplatinic acid and the ruthenium chloride were reduced respectively.

6. Demulsification: 20 mL of demulsifier (acetone) was added to the reverse micelle system in the condition of ultrasonic vibration, then the system was stood until the system was stratified.

7. Filtering, washing and drying: the solution was filtered, and then filter cake was washed with ethanol solution and deionized water for several times, and the obtained catalyst was vacuum dried for 2 hours at a temperature of 70° C., then a Pt—Ru nano-alloy/graphene catalyst was obtain.

### EXAMPLE 3

1. Preparation of graphite oxide: the graphite oxide was prepared according to the modified Hummers method. The specific steps were: 20 g 50 mesh of graphite powder, 10 g of potassium persulfate and 10 g of phosphorus pentoxide were added to concentrated sulfuric acid at a temperature of 80° C., and the mixture was stirred uniformly, cooled for more than 6 hours, washed to neutral and dried to obtain a sample. The dried sample was added to 250 mL of concentrated sulfuric acid at a temperature of 0° C., then 60 g of potassium permanganate was added, the temperature of the mixture was maintained below 20° C., and then maintained in the oil bath at a temperature of 35° C. for 2 hours, 920mL of deionized water was slowly added. 15 minutes later, 2.8 L of deionized water (containing 50 mL of hydrogen peroxide with a concentration of 30%) was then added, the mixture was hot filtrated while the color of the mixture became bright yellow, and then washed with 5 L of hydrochloric acid with a concentration of 10%, filtrated, and vacuum dried for 48 hours at a temperature of 60° C. to obtain the graphite oxide.

2. Preparation of graphite oxide solution: 0.5 g of obtained graphite oxide was added to 200 mL of water and dispersed by ultrasonic dispersion, a graphene oxide solution with uniform dispersion of monolithic layer was formed.

3. Preparation of reverse micelle system: dodecyl benzenesulfonic acid sodium salt, n-nonyl alcohol and cyclohexane were mixed together with a mass ratio of 100:70:10, and water was added according to a molar ratio of the dodecyl benzenesulfonic acid sodium salt and the water of 1:7 to obtain a mixed solution, the mixed solution was ultrasonic vibrated for 30 minutes, finally, chloroplatinic acid solution with a concentration of 0.04 mol/L and ruthenium chloride solution with a concentration of 0.04 mol/L were slowly added to the mixed solution dropwise, and ultrasonic vibrated for 30 minutes to form a transparent reverse micelle system.

4. Formation of precursors: 10% to 60%, the prepared graphene oxide solution was slowly added to the reverse micelle system dropwise, ultrasonic vibrated for 30 minutes. A mass ratio of the platinum-ruthenium alloy and the graphene was 1:10.

5. Reduction of precursors: excess hydrazine hydrate was added to the reverse micelle system in a water bath at a temperature of 80° C., and then ultrasonic vibrated for 2 hours, such that the graphene oxide, the chloroplatinic acid and the ruthenium chloride were reduced respectively.

6. Demulsification: 50 mL of demulsifier (anhydrous ethanol) was added to the system emulsion above in the condition of ultrasonic vibration, then the system was stood until the system was stratified.

7. Filtering, washing and drying: the solution was filtered, and then filter cake was washed with ethanol solution and deionized water for several times, and the obtained catalyst was vacuum dried for 2 hours at a temperature of 70° C., then a Pt—Ru nano-alloy/graphene catalyst was obtain.

### EXAMPLE 4

1. Preparation of graphite oxide: the graphite oxide was prepared according to the modified Hummers method. The specific steps were: 20 g 50 mesh of graphite powder, 10 g of potassium persulfate and 10 g of phosphorus pentoxide were added to concentrated sulfuric acid at a temperature of 80° C., and the mixture was stirred uniformly, cooled for more than 6 hours, washed to neutral and dried to obtain a sample. The dried sample was added to 240 mL of concentrated sulfuric acid at a temperature of 0° C., then 60 g of potassium permanganate was added, the temperature of the mixture was maintained below 20° C., and then maintained in the oil bath at a temperature of 35° C. for 2 hours, 920 mL of deionized water was slowly added. 15 minutes later, 2.8 L of deionized water (containing 50 mL of hydrogen peroxide with a concentration of 30%) was then added , the mixture was hot filtrated immediately while the color of the mixture became bright yellow, and then washed with 5 L of hydrochloric acid with a concentration of 10%, filtrated, and vacuum dried for 48 hours at a temperature of 60° C. to obtain the graphite oxide.

2. Preparation of graphite oxide solution: 0.5 g of obtained graphite oxide was added to 200 mL of water and dispersed by ultrasonic dispersion, a graphene oxide solution with uniform dispersion of monolithic layer was formed.

3. Preparation of reverse micelle system: quaternary ammonium salts, n-octanol and cyclohexane were mixed together with a mass ratio of 100:80:10, and water was added according to a molar ratio of the aliphatic quaternary ammonium salts and the water of 1:8 to obtain a mixed solution, the mixed solution was ultrasonic vibrated for 30 minutes, finally, chloroplatinic acid solution with a concentration of 0.04 mol/L and ruthenium chloride solution with a concentration of 0.04 mol/L were slowly added dropwise to the mixed solution, and ultrasonic vibrated for 30 minutes to form a transparent reverse micelle system.

4. Formation of precursors: 10% to 60%, the prepared graphene oxide solution was slowly added dropwise to the reverse micelle system, ultrasonic vibrated for 30 minutes. A mass ratio of the platinum-ruthenium alloy and the graphene was 1:10.

5. Reduction of precursors: excess sodium borohydride was added to the reverse micelle system in a water bath at a temperature of 80° C., and then ultrasonic vibrated for 2 hours, such that the graphene oxide, the chloroplatinic acid and the ruthenium chloride were reduced respectively.

6. Demulsification: 30 mL of demulsifier (acetone) was added to the reverse micelle system in the condition of ultrasonic vibration, then the system was stood until the system was stratified.

7. Filtering, washing and drying: the solution was filtered, and then filter cake was washed with ethanol solution and deionized water for several times, and the obtained catalyst was vacuum dried for 2 hours at a temperature of 70° C., then a nano-alloy Pt—Ru/graphene catalyst was obtain.

It should be understood that the descriptions of the examples are specific and detailed, but those descriptions can't be used to limit the present disclosure. Therefore, the scope of protection of the invention patent should be subject to the appended claims.

1. A preparation method of a Pt—Ru nano-alloy/graphene catalyst, comprising the following steps:
oxidizing graphite powder to obtain a graphite oxide according to a Hummers method;
adding the graphite oxide to water, forming a graphene oxide solution with uniform dispersion of monolithic layer after ultrasonic dispersion;
preparing a reverse micellar system containing a surfactant, a cosurfactant, an oil phase, a chloroplatinic acid, and a ruthenium chloride aqueous solution at room temperature;
adding the graphene oxide solution to the reverse micelle system dropwise, and adding a reducing agent dropwise in a water bath, performing a reduction reaction to obtain an emulsion containing Pt—Ru nano-alloy and graphene;
adding a demulsifier to the emulsion dropwise, and loading the Pt—Ru nano-alloy on a carrier of the graphene; and
filtering, washing, drying the graphene loaded with Pt—Ru nano-alloy to obtain the Pt—Ru nano-alloy/graphene catalyst.

2. The preparation method according to claim 1, wherein in the step of preparing the graphite oxide, comprising the following steps:
adding the graphite powder, a potassium persulfate and a phosphorus pentoxide to a concentrated sulfuric acid at a temperature of 80° C., and stirring uniformly, cooling, washing to neutral, and drying to obtain a sample;
adding the dried sample to 200 mL to 250 mL of concentrated sulfuric acid at a temperature of 0° C., and then adding a potassium permanganate, and heat preserving for 5 to 60 minutes at a temperature from 0° C. to 20° C., then maintaining for 1 to 2 hours in an oil bath at a temperature of 35° C., then slowly adding to deionized water containing a hydrogen peroxide to obtain a mixed solution; and
hot filtering the mixed solution when the color of the mixed solution becomes bright yellow, washing with hydrochloric acid, filtering, drying to obtain the graphite oxide.

3. The preparation method according to claim 2, wherein a mass ratio of the graphite powder, the potassium persulfate and the phosphorus pentoxide is 2:1:1.

4. The preparation method according to claim 2, wherein a mass of the potassium permanganate is 3 times of a mass of the graphite powder; a mass percentage concentration of the hydrogen peroxide is 30%.

5. The preparation method according to claim 1, wherein the surfactant is selected from the group consisting of sodium benzenesulfonate, sodium dodecyl benzenesulfonate, aliphatic sulfate and aliphatic quaternary ammonium salt; the cosurfactant is selected from the group consisting n-octanol, n-nonyl alcohol, n-heptanol and n-hexyl alcohol; the oil phase is cyclohexane; a molar concentration of the chloroplatinic acid is 0.04 mol/L, a molar concentration of the ruthenium chloride aqueous solution is 0.04 mol/L; a mass ratio of the surfactant, the cosurfactant and the oil phase is 10:7:1.

6. The preparation method according to claim 1, wherein a mass ratio of the Pt—Ru nano-alloy and the graphene in the emulsion containing Pt—Ru nano-alloy and graphene is 1:10.

7. The preparation method according to claim 1, wherein the reducing agent is hydrazine hydrate or sodium borohydride, a molar amount of the reducing agent is 3 to 10 times of a molar amount of the chloroplatinic acid.

8. The preparation method according to claim 1, wherein the demulsifier is acetone or anhydrous ethanol.

9. A Pt—Ru nano-alloy/graphene catalyst, prepared according to the preparation method of claim 1, wherein the graphene is a carrier, the Pt—Ru nano-alloy is loaded on the graphene.

10. A proton exchange membrane fuel cell, comprising the Pt—Ru nano-alloy/graphene catalyst provided according to claim 9.
